(19) United States
(12) Patent Application Publication
(10) Pub. No.: US 2023/0339141 A1
(43) Pub. Date: Oct. 26, 2023

(54) MANUAL LONG-LENGTH CERAMIC CUTTER

(71) Applicant: GERMANS BOADA, S.A., Rubi (ES)

(72) Inventors: Sergi FRANCH, Rubi (ES); Able RUAN, Rubi (ES)

(21) Appl. No.: 18/043,333

(22) PCT Filed: Jul. 14, 2021
(86) PCT No.: PCT/ES2021/070519

§ 371 Date: Feb. 27, 2023

(30) Foreign Application Priority Data
May 31, 2021 (WO) PCT/ES2021/070386

(51) Int. Cl. B28D 1/22

(52) U.S. Cl. CPC B28D 1/225

(57) ABSTRACT

The invention relates to a manual long-length ceramic cutter, comprising: a supporting base (1) for the piece to be cut; at least one longitudinal guide (2, 2a, 2b) installed above the base (1); and a head (3) for scoring and separating the ceramic pieces, operable manually and installed on at least one guide (2, 2a, 2b) that can move longitudinally. The cutter comprises at least one mobile support (4, 4a, 4b), having: an upper end (41) installed on the respective longitudinal guide (2, 2a, 2b), and a lower end (42) installed on at least one longitudinal track (11a, 11b) of the base (1), wherein said support can move longitudinally along the guide (2, 2a, 2b) and the corresponding track (11a, 11b), preventing the guide (2, 2a, 2b) from bending during the scoring and separation of short-length ceramic pieces.

### FIELD

The present invention is applicable in the field of technology dedicated to the manufacture of manual ceramic cutters, and in particular long-length cutters.

### BACKGROUND

Manual long-length ceramic cutters are known today, comprising: a supporting base for the ceramic piece to be cut; longitudinal guides installed above the base; and a head for scoring and cutting the ceramic pieces, operable manually and installed on said guides that can move longitudinally.

The cutting of short-length ceramic pieces by using manual long-length cutters significantly affects the performance of the cutter since, in the case of executing the cut with a point of support far from the end supports of the guides, said guides bend considerably, causing poor scoring and cutting of the ceramic piece, since the depth and straightness of the scoring mark is insufficient for the piece to split.

In addition, the excessive bending of the guides does not allow the application of the adequate load to cut or separate the ceramic piece along the marked line, sometimes making it impossible to separate said piece.

Therefore, the technical problem that is considered is the development of a manual long-length ceramic cutter with technical features that prevent the guides from bending when cutting short-length ceramic pieces.

It should be mentioned that the applicant for the invention is unaware of the existence on the market of manual long-length ceramic cutters that allow solving the problem considered and that have the features of the present invention.

### DESCRIPTION OF THE INVENTION

The manual long-length ceramic cutter of this invention is of the type described in the preamble of the main claim, comprising: a supporting base for the ceramic piece to be cut; a head for scoring and cutting the ceramic pieces, operable manually and installed such that it can move along longitudinal guide means located above the base and made up of a single central guide, or of two parallel guides.

In order to resolve the technical problem considered, this cutter comprises at least one mobile support having an upper end installed on the respective longitudinal guide of the cutter, and a lower end installed on at least one longitudinal track of the base, said support being able to move longitudinally, so that it can be positioned at any point of the guide located behind the cutting head, taking as a reference the direction of forward movement of said head during scoring of short-length ceramic pieces.

Said mobile support forms a support for the corresponding guide on the base, preventing said guide from bending during scoring and cutting of short-length ceramic pieces, successfully resolving the problem set out above.

Advantageously, in one embodiment of the invention, the cutter includes immobilisation means for immobilising the support, or mobile supports, either on the corresponding guide or on the base of the cutter, at any point of their travel, so that said supports are unable to move for as long as deemed appropriate.

According to one embodiment of the invention, each movable support comprises at its upper end a hole for the tight passage of the corresponding longitudinal guide, and at the lower end at least one slide installed on a longitudinal track of the base.

In the event that said mobile supports have immobilisation means at any point of their travel, said means can be made up, for example, of threaded knobs that act on the corresponding slide, immobilising it with respect to the corresponding track of the base.

Obviously, the means for connecting each mobile support with the corresponding guide and with the base can have different configurations, as long as they allow the longitudinal movement thereof, keeping said longitudinal guide at a certain distance from the base, preventing it from bending.

In the same way, the means for fixing the mobile supports can have different configurations, as long as they allow the immobilisation thereof at different points of their travel.

In one embodiment of the invention, the cutter comprises a single longitudinal guide arranged in correspondence with a longitudinal median plane of the base and a single mobile support having two diverging branches installed by means of respective slides on respective longitudinal tracks of the base.

In one embodiment variant, the cutter comprises two parallel longitudinal guides and two mobile supports, each one installed such that it can move along the guide and the corresponding track. In this embodiment, provision has been made for the mobile supports of the two guides to be attached to one another, moving simultaneously along the cutter, making it unnecessary to move them individually. Provision has also been made for the immobilisation means for immobilising the mobile supports at different points of their longitudinal travel may be made up of a single immobilising element with respect to the base or the guides.

### BRIEF DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows an elevational view of an exemplary embodiment of the manual long-length ceramic cutter according to the invention, having a single central guide for the movement of the marking head and a mobile support to prevent said central guides during the marking of short-length ceramic pieces.

FIG. 2 shows a profile view of the cutter sectioned by plane A-A′ referenced in FIG. 1.

FIG. 3 shows a perspective view of the cutter of FIGS. 1 and 2, and an enlarged detail of the installation area of the mobile support.

FIG. 4 shows a schematic perspective view of an embodiment variant of a long-length ceramic cutter according to the invention, having two longitudinal guides for the movement of the marking head and respective mobile supports to prevent the guides from bending during the marking of short-length ceramic pieces.

FIG. 5 shows an elevational view of the ceramic cutter of the preceding figure.

FIG. 6 shows a profile view of the cutter of FIGS. 4 and 5 sectioned by vertical plane B-B′ marked in FIG. 5 and which coincides with the vertical middle area of the mobile supports.

### DETAILED DESCRIPTION

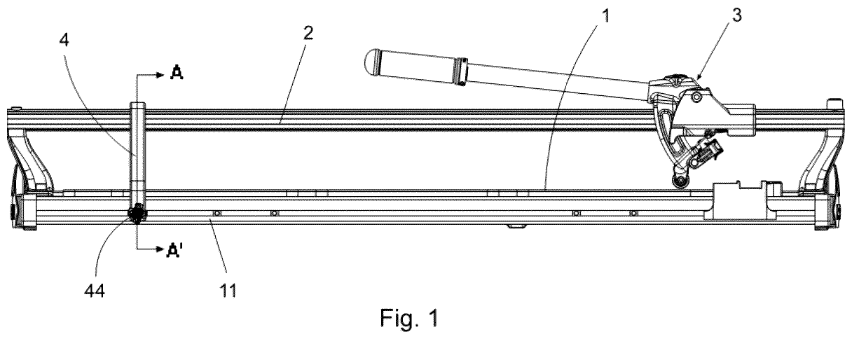

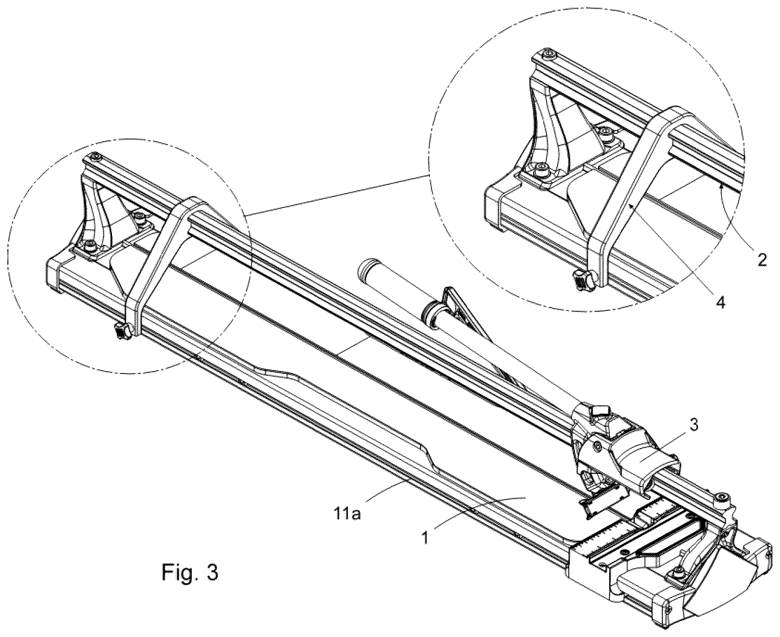

In the embodiment shown in FIGS. 1 to 3, the manual long-length ceramic cutter comprises a base 1 that defines a surface for supporting the ceramic pieces to be cut, a longitudinal guide (2) arranged in correspondence with a longitudinal median plane of the base (1) and installed at its ends on said base (1), and a head (3), manually movable along the guide (2), for scoring and separating the ceramic pieces positioned on the base (1).

In this embodiment, the manual cutter comprises a mobile support (4) installed at its upper end (41) installed on the mentioned guide (2) and at its lower end on longitudinal tracks (11a, 11b) defined on the sides of the base. (1).

The mentioned mobile support (4) is arranged behind the head (3), taking as a reference the direction of movement of said head (3) during the scoring of the ceramic pieces, and being able to move along the cutter.

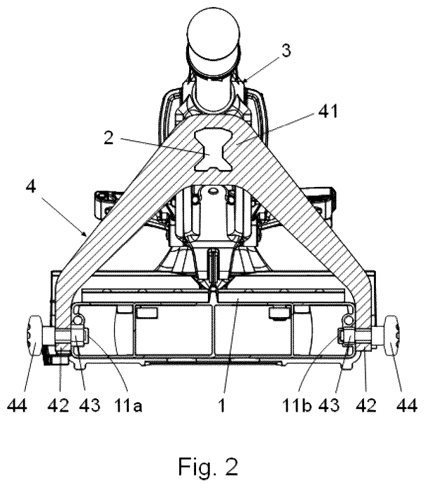

As can be seen in FIG. 2, said mobile support (4) has at its upper end (41) a hole for the tight passage of the guide (2) and has two branches diverging towards the lower area, the lower end (42) of the mobile support (4) comprising respective slides (43) which move along the tracks (11a, 11b) of the base (1).

It should be mentioned that the skates (43) can be made up of a material with a low coefficient of friction, bearings or any other element that allows the smooth movement thereof along the tracks (11a, 11b).

This mobile support (4) can therefore be arranged at any intermediate point of the cutter, forming an intermediate support for the guide (2) with respect to the base (1), said mobile support preventing the guide (2) from bending during the marking/scoring of short-length ceramic pieces, due to the pressure exerted by the head (3) on the guide (2).

The cutter includes immobilisation means for immobilising the mobile support (4) at any point of its travel, and which act either on the guide (2) or on the base (1). In this specific embodiment, said means are made up of threaded knobs (44) for immobilising the slides (43) with respect to the tracks (11a, 11b) of the base.

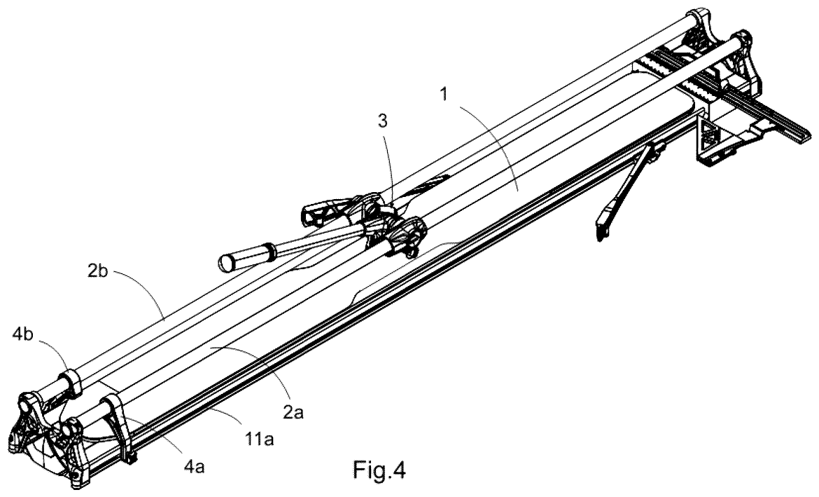

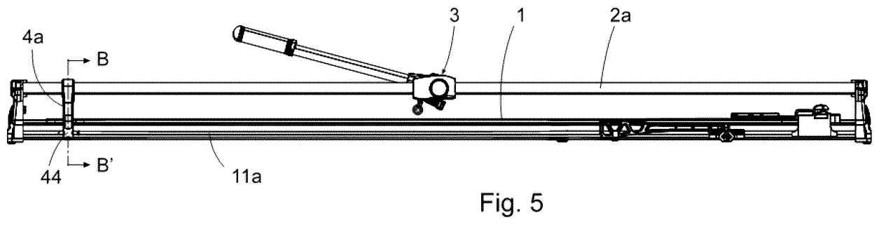

In the embodiment variant shown in FIGS. 4 to 6, the manual long-length ceramic cutter comprises two parallel longitudinal guides (2a, 2b), installed at their ends on the base (1), and a head (3) for scoring and separating the ceramic pieces, operable manually and installed on the guides (2a, 2b) that can move longitudinally.

In this embodiment, the cutter comprises two mobile supports (4a, 4b) arranged one on each side of the slicer and installed at the upper end (41) thereof in the corresponding guide (2a, 2b) and at the lower end (42) thereof in a track (11a, 11b) defined on the corresponding side of the base (1).

Said mobile supports (4a, 4b) can be moved longitudinally along the cutter and are arranged, as in the previous embodiment, behind the head (3), taking as a reference the direction of movement of said head during the scoring of the ceramic pieces.

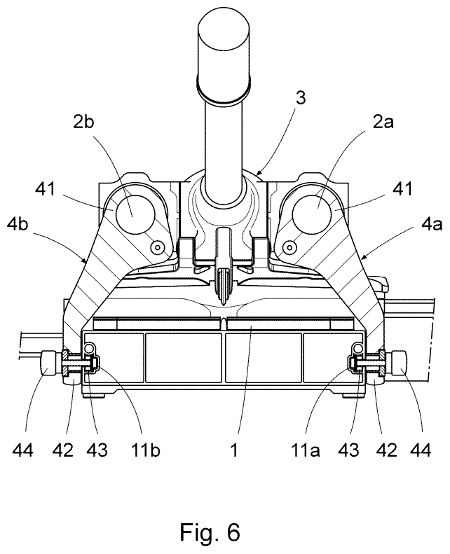

As can be seen in greater detail in FIG. 6, the mobile supports (4a, 4b) have at their upper end (41) a hole for the tight passage of the corresponding guide (2a, 2b) and at their lower end (42) a slide (43) housed in the corresponding track (11a, 11b) of the base (1) of the cutter.

Said mobile supports (4a, 4b), which form elements for attaching the longitudinal guides (2a, 2b) with the base (1), prevent said longitudinal guides from bending in the area for positioning said mobile supports (4a, 4b), guaranteeing a correct operation of the cutter when scoring and cutting short-length ceramic pieces, that is, a length that is considerably less than the total length of the guides (2a, 2b).

In this embodiment, the cutter comprises means for fixing the mobile supports (4a, 4b) at any point of their travel, represented, as in the previous embodiment, by threaded knobs (44) that allow the tightening of the slides (43) against the respective tracks (11a, 11b), locking the mobile supports (4a, 4b) in the desired position.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1. A manual long-length ceramic cutter, comprising:
a supporting base for a ceramic piece to be cut;
at least one longitudinal guide installed above the base; and
a head for scoring and separating the ceramic pieces, operable manually and installed on at least one guide that can move longitudinally, and comprising at least one mobile support having:
an upper end installed on the respective longitudinal guide, and
a lower end installed on at least one longitudinal track of the base;
wherein said support can move longitudinally along the guide and a corresponding track, said mobile support preventing the guide from bending during the scoring and separation of short-length ceramic pieces.

2. The manual cutter according to claim 1, further comprising an immobilizer configured to immobilize the mobile support on the corresponding guide, or on the base of the cutter, along its longitudinal travel.

3. The cutter according to claim 1, wherein the upper end of the mobile support (4, 4a, 4b) comprises a hole for tight passage of the corresponding longitudinal guide.

4. The cutter according to claim 2, wherein the lower end of the mobile support comprises at least one slide installed on a longitudinal track (11a, 11b) of the base.

5. The cutter according to claim 4, wherein the immobilizer comprises a threaded knob for immobilising the at least one slide with respect to the tracks (11a, 11b) of the base.

6. The manual cutter according to claim 1,
further comprising a single longitudinal guide (2) arranged in correspondence with a longitudinal median plane of the base and attached at its end to the base, and a single mobile support having two branches diverging towards a lower area, installed by respective slides on the longitudinal tracks of the base.

7. The manual cutter according to claim 1, further comprising two parallel longitudinal guides and respective mobile supports installed such that they can move along the guide and the corresponding track.

8. The cutter according to claim 7, wherein the mobile supports are attached to one another, and configured to move simultaneously along the cutter.

9. The cutter according to claim 8, wherein the the mobile supports are attached to one another with a single threaded knob for immobilising the supports at any point of their travel.
